(19) United States
(12) Patent Application Publication
(10) Pub. No.: US 2005/0083304 A1
(43) Pub. Date: Apr. 21, 2005

(54) Method and apparatus for dynamically searching a moving vector of an image stream

(75) Inventors: Ching-Pin Wang, Taipei City (TW); Li-Feng Kuo, Taipei City (TW)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsinchu (TW)

(21) Appl. No.: 10/895,057

(22) Filed: Jul. 21, 2004

(30) Foreign Application Priority Data
Oct. 15, 2003 (TW) 092128523

(51) Int. Cl. G09G 3/36; G09G 5/08

(52) U.S. Cl. 345/166

(57) ABSTRACT

A method and apparatus for dynamically searching moving vector of an image stream, which captures a previous image for determining a target area in the previous image, captures a current image at a next sampling time for comparing the previous image and the current image so that a matched area with the target area is found to accordingly determine a moving vector and offset in the image stream, captures a next image at a next sampling time for determining an estimated area in the next image in accordance with the moving vector and further updates the moving vector and offset in the image stream in accordance with matched part found in the estimated area as compared with the target area.

### BACKGROUND OF THE INVENTION

1. Field of the Invention

The present invention relates to the technical field of image processing and, more particularly, to a method and apparatus for dynamically searching a moving vector of an image stream.

2. Description of Related Art

A typical optical mouse applies first a light-emitting diode (LED) to illuminate a mouse pad corresponding to the mouse or other object in order to obtain an image via an image sensor, and then the image sensor captures another image on the mouse pad, thus a moving vector of the optical mouse is found by comparing the two images. The moving vector is the moved distance of the mouse between two sampling points. As shown in FIG. 1, circle A is an image range captured by the image sensor when the LED illuminates on the mouse pad or another object. For image comparison, square range B is applied for consecutive captured images. For illustrative purpose, triangle C is an object in the captured image range.

When the optical mouse is moved to the left upper corner, an image captured by the image sensor is moved to the right lower corner as shown in FIG. 1. A circular block indicated with t1 represents an original captured image at time t1 while a circular block indicated with t2 represents a captured image after the optical mouse is moved to the left upper corner at time t2. In the circular block at time t2, there is a dotted line to indicate an original triangle C and a solid line to indicate a triangle C′ that the optical mouse is moved to the left upper corner. In the prior art, two images at time t1 and t2 are compared in a range of square B for finding a moving vector D. The moving vector D is the moved distance of the optical mouse in a sampling interval. However, such a prior art requires comparing entire square B and it wastes much computation time and energy. Therefore, it is desirable to provide an improved method and apparatus to mitigate and/or obviate the aforementioned problems.

### SUMMARY OF THE INVENTION

The object of the invention is to provide a method and apparatus for dynamically searching a moving vector of an image stream, which eliminates search and comparison on an entire frame in the prior art and thus avoids significant computation time and energy waste, thereby effectively reducing power consumption and achieving the purpose of saving power.

In accordance with one aspect of the present invention, there is provided a method for dynamically searching a moving vector of an image stream. The method includes the steps: (A) capturing an image for determining a target area in the image; (B) capturing a new image at a next sampling time for comparing the new image with the target area in the image and thus finding a matched area in the new area in order to determine a moving vector and offset in the image stream; and (C) capturing another next image at another next sampling time for determining an estimated area in the next image in accordance with the moving vector and further updating the moving vector and offset in the image stream in accordance with a matched part found in the estimated area as compared with the target area.

In accordance with another aspect of the invention, there is provided an apparatus for dynamically searching a moving vector of an optical mouse. The apparatus includes an image sensor, a memory unit, and an image and moving vector processor. The image sensor extracts images. The memory unit stores the images captured by the image sensor. The processor is connected to the memory unit. When the image sensor captures a first image and stores it in the memory unit, the processor determines a target area in the first image. When the image sensor captures a second image and stores it in the memory unit, the processor compares the target area with the second image to accordingly find a matched area in the second image and determine a moving vector and offset in the image stream. When the image sensor captures a third image and stores it in the memory unit, the processor determines an estimated area in the third image in accordance with the moving vector and further updates the moving vector and offset in the image stream in accordance with matched part found in the estimated area as compared with the target area.

Other objects, advantages, and novel features of the invention will become more apparent from the following detailed description when taken in conjunction with the accompanying drawings.

### BRIEF DESCRIPTION OF THE DRAWINGS

FIG. 1 is a schematic chart of a conventional optical mouse operation;

FIG. 2 is a block diagram of an apparatus for dynamically searching a moving vector of an image stream in accordance with the invention;

FIG. 3 is a flowchart of a method for dynamically searching a moving vector of an image stream in accordance with the invention; and

FIGS. 4-6 are schematic charts of operations of FIG. 3 in accordance with the invention.

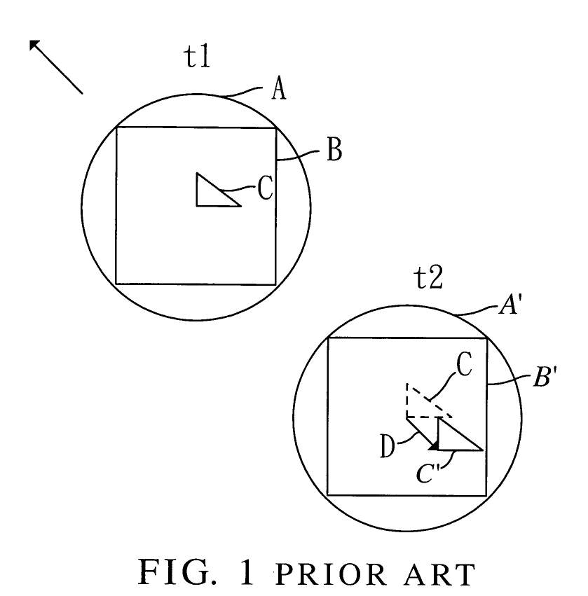

### DETAILED DESCRIPTION OF THE PREFERRED EMBODIMENT

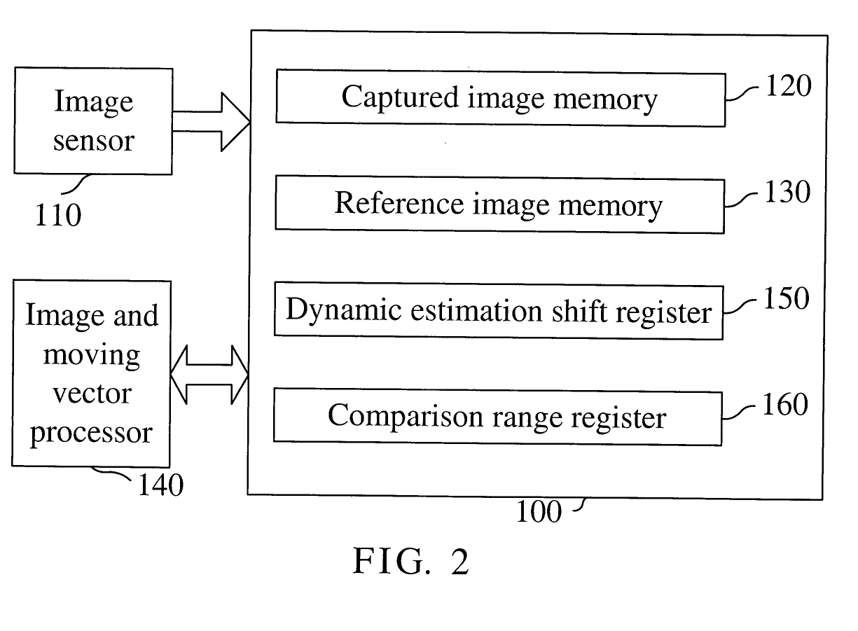

FIG. 2 is a block diagram of an apparatus for dynamically searching a moving vector of an image stream in accordance with the invention. In the embodiment, the image stream is generated by moving a computer input device, such as an optical mouse. As shown, the apparatus includes an image sensor 110, a memory unit 100, and an image and moving vector processor 140. The image sensor 110 captures an image on a working plane. The memory unit 100 has a captured image memory 120, a reference image memory 130, a dynamic estimation shift register 150 and a comparison range register 160. The captured image memory 120 is connected to the image sensor 110 for storing a current captured image. The reference image memory 130 stores a previous image in the memory 120 as a comparison image for comparison with the current image. The dynamic estimation shift register 150 stores a dynamically estimated moving vector. The comparison range register 160 stores a range of target area for comparison. The image and moving vector processor 140 stores the previous image in the memory 120 to the reference image memory 130 when the image sensor 110 is capturing a new image as the current captured image and subsequently stores the new image to the memory 120, so as to perform image processing and compute moving vectors.

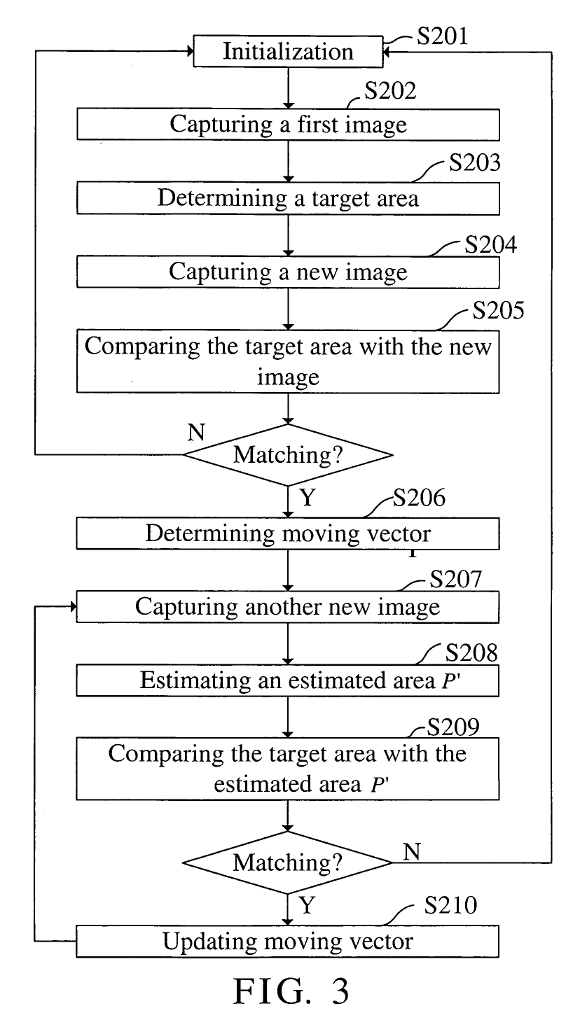

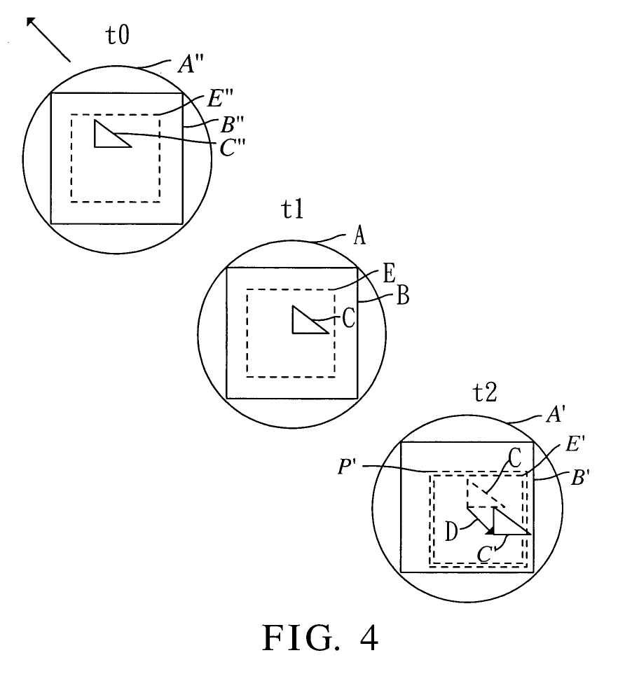

FIG. 3 is a flowchart of a method for dynamically searching a moving vector of an image stream in accordance with the invention. FIGS. 4-6 are schematic charts of operations of FIG. 3 in accordance with the invention. In FIG. 4, circle A is an image range captured by the image sensor 110, and accordingly square range B is applied for consecutive captured images. Also, triangle C is an object in the captured image range, and dotted square E is a range of target area assigned by the comparison range register 140.

When the optical mouse moves to the left upper corner, an image captured by the image sensor 110 moves to the right lower corner, as shown in FIG. 4. The circular block indicated by time t0 is an initial captured image, the circular block indicated by time t1 is a captured image after the optical mouse moves to the left upper corner, the circular block indicated by time t2 is a captured image after the optical mouse moves to the left upper corner again. In the circular block indicated by the time t2, the dotted triangle C represents an original triangle and the solid triangle C′ represents a moved triangle that the optical mouse has moved.

As shown in FIG. 3, first, in step S201, the captured image memory 120, the reference image memory 130, the dynamic estimation shift register 140 and the comparison range register 160 are initialized. In step S202, the image sensor 110 captures a first image (time t0) and stores it to the captured image memory 120. In step 203, the image and moving vector processor 140 determines a sub-image E″ as a target area in a captured image B″ in accordance with the range of target area in the comparison range register 160. In this embodiment, the target area is preferably located in the center of the captured image B″.

In step S204, the image sensor 110 captures a new image (time t1) as the optical mouse moves. At this point, the first image in the captured image memory 120 is stored in the reference image memory 130 while the new image is stored in the captured image memory 120. Such an arrangement of storage is convenient for a following image comparison.

In step S205, the image and moving vector processor 140 compares the target area E″ in the previous (first) image with the current (new) image B in order to find the same area or a matched area in the current image B, thereby determining the optical mouse's moving vector and offset and further storing the moving vector in the dynamic estimation shift register 150 (step S206). The aforementioned comparison can be performed by a second order momentum method, a mean squared error (MSE), or the like.

Next, in step S207, the image sensor 110 captures another new image at time t2. At this point, the previous (new) image in the captured image memory 120 is stored in the reference image memory 130 while the current (another new) image is stored in the captured image memory 120. In accordance with the moving vector in the dynamic estimation shift register 150 and the range of target area in the comparison range register 160, the image and moving vector processor 140 estimates that the range of target area is located in area E′ at time t2. Accordingly, in step S208, a current sub-area P′ is captured as an estimated area from the captured image memory 120 and the range of the sub-area P′ is greater than or equal to the range of target area E′. Next, in the step S209, the estimated area P′ is compared to the target area E in the reference image memory 130 in order to find the same area or a matched area in the estimated area P′ and accordingly update the optical mouse's moving vector and offset. Next, in the step S210, the moving vector updated is stored in the dynamic estimation shift register 150. The aforementioned comparison can be performed by a second order momentum method, a mean squared error (MSE), or the like.

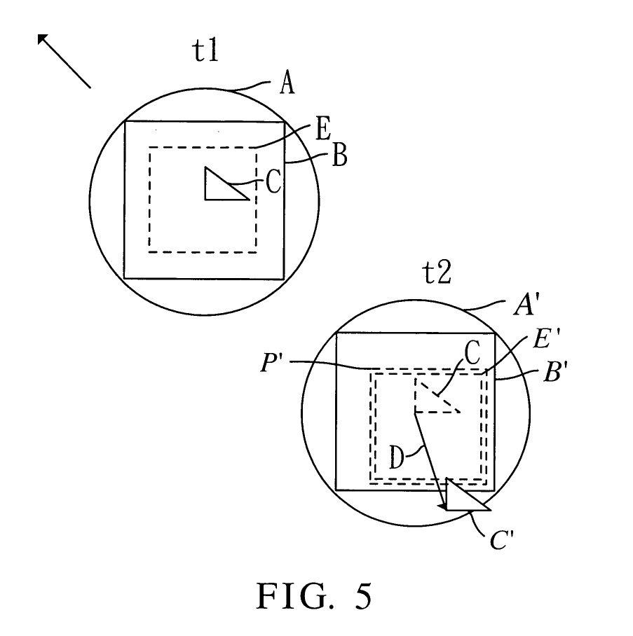

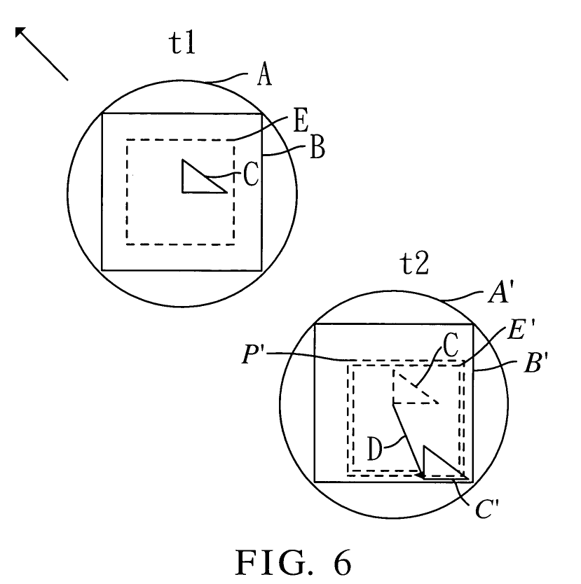

If the same area as E cannot be found in the estimated area P′, it represents that the moving vector in the dynamic estimation shift register 150 is not correct. As such, a corresponding triangle C′ to triangle C included in the previous image's target area E is not found in current image's estimated area P′. This may be a situation as shown in FIG. 5 that the corresponding triangle C′ is out of the range of the estimated area P′. In this case, step S201 is returned to perform the initialization. If none is matched with E in the entire current image B′, it may be a situation as shown in FIG. 6 that a corresponding triangle C′ to triangle C included in the previous image's target area E is not found in current image B′. In this case, the procedure returns to step S201 to perform the initialization.

In view of the foregoing, it is known that the invention can dynamically estimate the optical mouse's moving vector through the dynamic estimation shift register and the comparison range register, and perform dynamic search by adjusting the selected location for the reference image and next image comparison range in accordance with the moving vector dynamically estimated. Therefore, since searching the entire frame of a captured image is not necessary, the computation amount is relatively reduced to thus avoid wasting computation time and energy incurred in the prior art. Further, power consumption in the chip is effectively reduced and the purpose of saving power is achieved.

Although the present invention has been explained in relation to its preferred embodiment, it is to be understood that many other possible modifications and variations can be made without departing from the spirit and scope of the invention as hereinafter claimed.

1. A method for dynamically searching a moving vector of an image stream, comprising the steps of:
(A) capturing an image for determining a target area in the image;
(B) capturing a new image at a next sampling time for comparing the new image with the target area in the image and thus finding a matched area in the new area in order to determine the moving vector and offset in the image stream; and
(C) capturing another next image at another next sampling time for determining an estimated area in the next image in accordance with the moving vector and further updating the moving vector and offset in the image stream in accordance with a matched part found in the estimated area as compared with the target area.

2. The method as claimed in claim 1, wherein in step (A), the target area is located in a center of the image captured.

3. The method as claimed in claim 2, wherein in step (C), the estimated area has a range greater than or equal to that of the target area.

4. The method as claimed in claim 2, wherein step (C) is performed repeatedly to obtain a current moving vector and offset in the image stream.

5. The method as claimed in claim 4, wherein in step (C), if the matched part is not found in the estimated area, step (A) is performed.

6. The method as claimed in claim 5, wherein in step (C), if the matched area is not found in the another next image, step (A) is performed.

7. The method as claimed in claim 1, wherein the image stream is generated by moving an optical mouse.

8. An apparatus for dynamically searching a moving vector of an image stream, comprising:
an image sensor for capturing images;
a memory unit for storing the images captured by the image sensor; and
an image and moving vector processor connected to the memory unit;
wherein when the image sensor captures a first image and stores it in the memory unit, the processor determines a target area in the first image; when the image sensor captures a second image and stores it in the memory unit, the processor compares the target area with the second image to accordingly find a matched area in the second image and further determine a moving vector and offset in the image stream; and when the image sensor captures a third image and stores it in the memory unit, the processor determines an estimated area in the third image in accordance with the moving vector and further updates the moving vector and offset in the image stream in accordance with a matched part found in the estimated area as compared with the target area.

9. The apparatus as claimed in claim 8, wherein the target area is located in a center of the image captured.

10. The apparatus as claimed in claim 8, wherein the estimated area has a range greater than or equal to that of the target area.

11. The apparatus as claimed in claim 10, wherein the processor performs an initialization procedure to determine a target area in the first captured image if the matched part is not found in the estimated area.

12. The apparatus as claimed in claim 8, wherein the image stream is generated by moving an optical mouse.
